(19) United States
(12) Patent Application Publication
(10) Pub. No.: US 2018/0336193 A1
(43) Pub. Date: Nov. 22, 2018

(54) Artificial Intelligence Based Method and Apparatus for Generating Article

(71) Applicant: BEIJING BAIDU NETCOM SCIENCE AND TECHNOLOGY CO., LTD., Beijing (CN)

(72) Inventors: Kai LIU, Beijing (CN); Hao LIU, Beijing (CN); Yajuan LV, Beijing (CN)

(21) Appl. No.: 15/942,330

(22) Filed: Mar. 30, 2018

(30) Foreign Application Priority Data
May 18, 2017 (CN) 201710352222.3

(51) Int. Cl. G06F 17/28; G06N 7/00; G06F 17/24; G06N 99/00; G06F 17/30

(52) U.S. Cl. CPC G06F 17/2881; G06N 7/00; G06F 17/30038; G06N 99/005; G06F 17/248

(57) ABSTRACT

The present disclosure discloses an artificial intelligence based method and apparatus for generating an article. A specific embodiment of the method comprises: acquiring predetermined structure data for generating an article; generating candidate sentences from the predetermined structure data using a sentence generation model; forming a chapter by splicing candidate sentences selected according to a probability for a sentence containing a preset information point appearing, wherein each time a candidate sentence is selected, candidate sentences relating to the selected candidate sentence are excluded according to a preset exclusion rule; and generating an article based on the chapter formed by splicing, in response to no candidate sentence being available.

### CROSS-REFERENCE TO RELATED APPLICATIONS

This application is related to and claims priority from Chinese patent application no. 201710352222.3, filed with the state intellectual property office (SIPO) of the People's Republic of China on May 18, 2017, the entire disclosure of the Chinese patent application is hereby incorporated by reference.

### TECHNICAL FIELD

The present application relates to the field of computer technology, specifically to the field of Internet technology, and more specifically to an artificial intelligence based method and apparatus for generating an article.

### BACKGROUND

Artificial Intelligence, abbreviated as AI, is a technological science which researches on and develops theories, methods, techniques and application systems for simulating, extending and expanding human intelligence. As a branch of the computer science, artificial intelligence attempts to learn the principle of intelligence and produce a novel intelligent machine capable of making response in a way similar to human intelligence. The researches in this field include robot, language recognition, image recognition, natural language processing and expert systems, etc.

In natural language processing applications, articles which generate natural language expressions from the computer data are involved. The existing methods for generating articles usually utilize an article structure template to splice various types of sentences with a certain structure, requiring the manual compilation of a large number of splicing logic templates corresponding to chapter structures. Once a new type of sentence is added to the current article generation process, it may become necessary to modify and adjust the large number of chapter structure corresponding splicing logic templates. As for the non-predetermined structure data, it does not work in the article generation process. Therefore, artificial intelligence may be applied to the sentence selection, and various data may also be made full use of, to improve the effectiveness of article generation.

### SUMMARY

The objective of the present disclosure is to provide an improved artificial intelligence based method and apparatus for generating an article, in order to solve the technical problem mentioned in the foregoing Background section.

In a first aspect, the present disclosure provides an artificial intelligence based method for generating an article, the method including: acquiring predetermined structure data for generating an article; generating candidate sentences from the predetermined structure data using a sentence generation model; forming a chapter by splicing candidate sentences selected according to a probability for a sentence containing a preset information point appearing, wherein each time a candidate sentence is selected, candidate sentences relating to the selected candidate sentence are excluded according to a preset exclusion rule; and generating an article based on the chapter formed by splicing, in response to no candidate sentence being available.

In some embodiments, the acquiring predetermined structure data for generating an article includes: capturing data by subject from a predetermined website, wherein the captured data includes predetermined structure data and non-predetermined structure data; and structuralizing the non-predetermined structure data according to a data structure of the predetermined structure data, into predetermined structure data.

In some embodiments, the forming a chapter by splicing candidate sentences selected according to a probability for a sentence containing a preset information point appearing includes: selecting the candidate sentence as a paragraph-initiating sentence according to a probability for a sentence appearing at a beginning of the paragraph; selecting successively the candidate sentence according to a probability for a sentence connecting a preceding sentence and splicing the sentence to form a chapter; or selecting the candidate sentence as a paragraph-ending sentence according to a probability for a sentence appearing at an end of the paragraph; and selecting successively the candidate sentences according to a probability for a sentence connecting a rearing sentence and arranging the sentence forward to form a chapter.

In some embodiments, the forming a chapter by splicing candidate sentences selected according to a probability for a sentence containing a preset information point appearing includes: selecting, for each preset information point, a sentence having a highest sentence generation probability as a to-be-used sentence corresponding to the preset information point; and determining an arrangement order of the to-be-used sentence having a highest arrangement probability based on a preset chapter combination model, to form a chapter by splicing.

In some embodiments, the generating an article based on the chapter formed by splicing, in response to no candidate sentence being available includes: acquiring multimedia material associated with a theme of a to-be-generated article, wherein the multimedia material includes at least one of: a picture, an animation, an audio, and a video; and generating the article by selecting multimedia material from the multimedia material based on the formed chapter together with the formed chapter, in response to no candidate sentence being available.

In a second aspect, the present disclosure further provides an artificial intelligence based apparatus for generating an article, the apparatus including: a data acquisition module, configured for acquiring predetermined structure data for generating an article; a sentence generation module, configured for generating candidate sentences from the predetermined structure data using a sentence generation model; a sentence splicing module, configured for forming a chapter by splicing candidate sentences selected according to a probability for a sentence containing a preset information point appearing, wherein each time a candidate sentence is selected, candidate sentences relating to the selected candidate sentence are excluded according to a preset exclusion rule; and an article generation module, configured for generating an article based on the chapter formed by splicing, in response to no candidate sentence being available.

In some embodiments, the data acquisition module is further configured for: capturing data by subject from a predetermined website, wherein the captured data includes predetermined structure data and non-predetermined structure data; and structuralizing the non-predetermined structure data according to a data structure of the predetermined structure data, into predetermined structure data.

In some embodiments, the sentence splicing module is further configured for: selecting the candidate sentence as a paragraph-initiating sentence according to a probability for a sentence appearing at a beginning of the paragraph; selecting successively the candidate sentence according to a probability for a sentence connecting a preceding sentence and splicing the sentence to form a chapter; or selecting the candidate sentence as a paragraph-ending sentence according to a probability for a sentence appearing at an end of the paragraph; and selecting successively the candidate sentences according to a probability for a sentence connecting a rearing sentence and arranging the sentence forward to form a chapter.

In some embodiments, the sentence splicing module is further configured for: selecting, for each preset information point, a sentence having a highest sentence generation probability as a to-be-used sentence corresponding to the preset information point; and determining an arrangement order of the to-be-used sentence having a highest arrangement probability based on a preset chapter combination model, to form a chapter by splicing.

In some embodiments, the article generation module includes: a multimedia material acquisition unit, configured for acquiring multimedia material associated with a theme of a to-be-generated article, wherein the multimedia material includes at least one of: a picture, an animation, an audio, and a video; and an article generation unit, configured for generating the article by selecting multimedia material from the multimedia material based on the formed chapter together with the formed chapter, in response to no candidate sentence being available.

In a third aspect, the present disclosure further provides a computing device, including: one or more processors; a storage apparatus, to store one or more programs; and when the one or more programs being executed by the one or more processors, cause the one or more processors to implement the above method.

The artificial intelligence based method and apparatus for generating an article provided by the present disclosure acquire predetermined structure data for generating an article, generate candidate sentences from the predetermined structure data using a sentence generation model, then form a chapter by splicing candidate sentences selected according to a probability for a sentence containing a preset information point appearing, wherein each time a candidate sentence is selected, candidate sentences relating to the selected candidate sentence are excluded according to a preset exclusion rule, and generate an article based on the chapter formed by splicing, in response to no candidate sentence being available. Since sentences may be selected by the preset information points, relevant sentences are excluded when each time a sentence is selected, and until there are no available sentences the article generation is completed, thus the effectiveness of generating an article may be improved.

### BRIEF DESCRIPTION OF THE DRAWINGS

After reading detailed descriptions of non-limiting embodiments with reference to the following accompanying drawings, other features, objectives and advantages of the present disclosure will be more apparent:

FIG. 1 is an exemplary system architecture diagram in which the present disclosure may be applied;

FIG. 2 is a flowchart of an embodiment of an artificial intelligence based method for generating an article according to the present disclosure;

FIG. 3 is a schematic diagram of an application scenario of an embodiment of the artificial intelligence based method for generating an article according to the present disclosure;

FIG. 4 is a flowchart of another embodiment of the artificial intelligence based method for generating an article according to the present disclosure;

FIG. 5 is a schematic structural diagram of an embodiment of an artificial intelligence based apparatus for generating an article according to the present disclosure; and

FIG. 6 is a schematic structural diagram of a computer system adapted to implement a terminal device or a server of embodiments of the present disclosure.

### DETAILED DESCRIPTION OF EMBODIMENTS

The present application will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

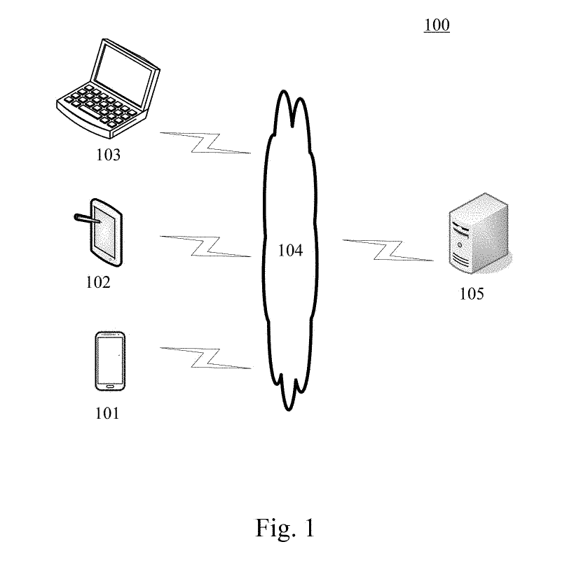

FIG. 1 shows an illustrative architecture of a system 100 which may be used by an artificial intelligence based method for generating an article or an artificial intelligence based apparatus for generating an article according to the embodiments of the present application.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, such as wired or wireless transmission links, or optical fibers.

The user 110 may use the terminal devices 101, 102 and 103 to interact with the server 105 through the network 104, in order to transmit or receive messages, etc. Various communication client applications, such as browser applications, search applications, article generating applications, shopping applications, instant messaging tools, mailbox clients, and social platform software may be installed on the terminal devices 101, 102 and 103.

The terminal devices 101, 102 and 103 may be various electronic devices having a computing capacity, including but not limited to, smart phones, tablet computers, e-book readers, MP3 (Moving Picture Experts Group Audio Layer III) players, MP4 (Moving Picture Experts Group Audio Layer IV) players, laptop computers and desktop computers.

The server 105 may be a server that provides various services, for example, a backend server that provides support for browser applications, search applications, article generation applications, etc. on the terminal devices 101, 102, 103. The server 105 may perform processing such as analyzing on the received data, and feed back the processing result (for example, a generated article) to the terminal devices.

It needs to be noted that the artificial intelligence based method for generating an article provided by the present disclosure may be executed by the server 105, or may be executed by the terminal devices 101, 102 and 103. Accordingly, the artificial intelligence based apparatus for generating an article may be provided in the server 105, or may be provided in the terminal devices 101, 102 and 103.

It should be understood that the numbers of the terminal devices, the networks and the servers in FIG. 1 are merely illustrative. Any number of terminal devices, networks and servers may be provided based on the implementation requirements. For example, the numbers of the servers and the networks may be zero, when embodiments of the artificial intelligence based method for generating an article and the artificial intelligence based apparatus for generating an article of the present disclosure are applied to a terminal device.

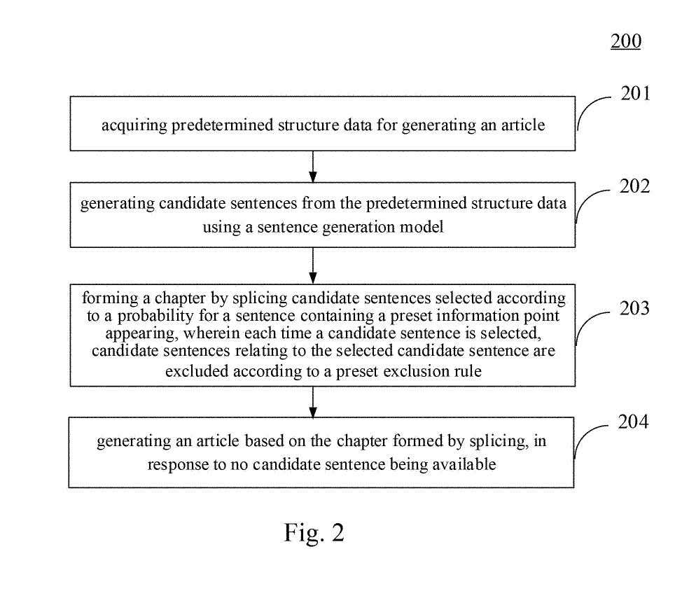

With further reference to FIG. 2, a flow 200 of an embodiment of the artificial intelligence based method for generating an article according to the present disclosure is illustrated. The artificial intelligence based method for generating an article includes the following steps:

Step 201, acquiring predetermined structure data for generating an article.

In the present embodiment, the electronic device (e.g., the server 105 as shown in FIG. 1) on which the artificial intelligence based method for generating an article runs may first acquire predetermined structure data for generating an article locally or remotely. Here, the predetermined structure data may be data having a predetermined storage structure, for example, data stored through a table, data stored through a database such as a structured query language (SQL) database, etc.

It may be understood that the electronic device may first acquire the theme of a to-be-generated article and then acquire predetermined structure data associated with the theme as the predetermined structure data for generating the article. The predetermined structure data may be stored on the electronic device in advance, or may be acquired by the electronic device from other electronic devices (such as a backend server that provides support for a predetermined website) based on the determined theme, and may also be generated by the electronic device based on data of a non-predetermined structure. For example, a sports report article about a certain game is to be generated by the electronic device, then the electronic device may capture data relating to the game from a backend server that provides support for the official website of the game. These data may be predetermined structure data (such as tabular data), or may be non-predetermined structure data (such as live-streaming data and picture description data). When the data acquired by the electronic device includes non-predetermined structure data, if the acquired data further includes predetermined structure data, the electronic device may generate predetermined structure data by extracting a keyword from the non-predetermined structure data according to the acquired predetermined structure data; if the acquired data does not include predetermined structure data, the electronic device may generate predetermined structure data by extracting a keyword from the non-predetermined structure data according to a set predetermined structure data. If the non-predetermined structure data includes live-streaming data “the game moves to the 20th minute of the second half, Party A suddenly scores two goals in a row,” the predetermined structure data is generated by extracting the keywords “the 20th minute of the second half,” “Party A” and “two goals in a row” according to the preset storage structure “time role event” of the predetermined structure data. Thus, the electronic device may make full use of the predetermined structure data and the non-predetermined structure data during the article generation process.

In some implementations, after the predetermined structure data for generating an article is acquired, the electronic device may further calculate the predetermined structure data to obtain a preset parameter. For example, for a football game, parameters such as the number of goals, playing time and number of errors of a certain player are counted through calculations such as summation and counting the sum.

Step 202, generating candidate sentences from the predetermined structure data using a sentence generation model.

In the present embodiment, the electronic device (e.g., the server 105 as shown in FIG. 1) on which the artificial intelligence based method for generating an article runs may then generate candidate sentences from the predetermined structure data using a preset sentence generation model.

The electronic device may generate candidate sentences for each piece of predetermined structure data according to the predetermined structure data, and may also generate one or more candidate sentences for each information point according to different information points. Here, the information point is used to indicate a key point to be reflected in the article to be generated, such as time and the result of the game. The information point may be preset, or may be obtained by calculation based on the predetermined structure data. Each piece of predetermined structure data may correspond to one or more information points. In some implementations, the electronic device may generate candidate sentences by a method of filling the predetermined structure data or the information point into a preset template, for example, filling a piece of predetermined structure data “{year: 2017}, {month: 2}, {day: 23}” into a preset template “x month x day, x year, Beijing time” to generate the candidate sentence “Feb. 23, 2017, Beijing time.” In some other implementations, the electronic device may also generate candidate sentences using a machine learning model such as a multilayer Recurrent Neural Network (RNN). In this case, the electronic device may obtain the sentence generation model from training in advance based on the match of a plurality of different natural language description texts and the information points in the predetermined structure data, input the information points in the sentence generation process, and may generate a plurality of different natural language description texts. For example, for the information points “{Rockets: 110}, {Grizzlies: 108}, {Victory: Rockets},” candidate sentences such as “The Rockets beats the Grizzlies at 110: 108,” “The Grizzlies loses to the Rockets at 108: 110” and “The Rockets edges out the Grizzlies by 2 points” may be generated.

Step 203, forming a chapter by splicing candidate sentences selected according to a probability for a sentence containing a preset information point appearing, wherein each time a candidate sentence is selected, candidate sentences relating to the selected candidate sentence are excluded according to a preset exclusion rule.

In the present embodiment, the electronic device (e.g., the server 105 as shown in FIG. 1) on which the artificial intelligence based method for generating an article runs may preset information points required for generating an article, the electronic device may further select candidate sentences and splice the candidate sentences to form a chapter, based on the preset information points, according to the probability for the sentence containing the preset information point appearing. Here, the electronic device may further store a preset exclusion rule for excluding unusable sentences. Specifically, each time a candidate sentence is selected, the electronic device may exclude candidate sentences relating to the selected candidate sentence according to the preset exclusion rule.

The electronic device may, for each preset information point, select a candidate sentence having the highest probability of occurrence. Here, the probability of occurrence of a sentence is calculated by at least one of the following models including but not limited to: a distinguishing classification machine learning model (the Support Vector Machine SVM, the maximum entropy, the perceptron, the neural network, etc.), a generating classification machine learning model (the language model, the sequence to sequence deep network, etc.), a regression model (the linear regression, etc.) and so on. The training process of the above models may be: taking an article relating to the theme of the to-be-generated article as a sample, performing paragraph and sentence segmentation on the sample article, training a paragraph segmentation probability and a sentence segmentation probability using the machine learning method. Here, the paragraph/sentence segmentation probability may include, but not limited to, at least one of the following: the probability for the current sentence and the preceding sentence/paragraph having a direct sentence-to-sentence connection; the probability for the current sentence and the preceding sentence/paragraph having a direct paragraph-to-paragraph connection; the probability for the current sentence and the preceding sentence/paragraph not having a direct connection. The above connection may include, but not limited to, the N-gram feature, the Embedding feature, the noun feature, the entity word feature, the syntactic feature, and the transitional word feature, etc.

When selecting sentences, the electronic device may select from the front to the back in sequence or from the back to the front in sequence, which is not limited in the present disclosure. When selecting the sentences from the front to the back, the electronic device may first determine, according to the preset information point, the candidate sentence having the highest probability of appearing at the beginning of the paragraph in the candidate sentences generated in step 202 as the paragraph-initial sentence, and then select the candidate sentences in sequence and splice the sentences to forma chapter, according to the connection probability between the candidate sentences corresponding to the other information points and the preceding sentence. When selecting the sentences from the back to the front, the electronic device may first determine, according to the preset information point, the candidate sentence having the highest probability of appearing at the end of the paragraph in the candidate sentences generated in step 202 as the paragraph-end sentence, and then select the candidate sentences in sequence and arrange forward the sentences to form a chapter, according to the probability for the sentence connecting the next sentence.

For example, the following is illustrated as an example of selecting sentences in sequence from the front to the back. It is supposed that the to-be-generated article is an article relating to the theme of a game between the Rockets and the Grizzlies. The predetermined structure data includes: “{Year: 2017}, {Month: 2}, {Day: 23},” “{Month: 2}, {Day: 23}, {Rockets: 110}, {Grizzlies: 108}, {Victory: Rockets},” “{Rockets: 110}, {Grizzlier: 108},” “{Rockets: 110}, {Grizzlies: 108}, {Victory: Rockets},” and candidate sentences are generated from these predetermined structure data using the sentence generation model respectively includes:

{Year: 2017}, {Month: 2}, {Day: 23}==>“Feb. 23, 2017, Beijing time”;

{Month: 2}, {Day: 23}, {Rockets: 110}, {Grizzlies: 108}, {Victory: Rockets}==>“On February 23, the Rockets beats the Grizzlies at 110: 108”;

{Rockets: 110}, {Grizzlier: 108}==>“The Rockets VS the Grizzlies”;

{Rockets: 110}, {Grizzlies: 108}, {Victory: Rockets}==>“The Rockets beats the Grizzlies by 110: 108”;

{Rockets: 110}, {Grizzlies: 108}, {Victory: Rockets}==>“The Grizzlies loses to the Rockets at 108: 110”;

{Rockets: 110}, {Grizzlies: 108}, {Victory: Rockets}==>“The Rockets edges out the Grizzlies by 2 points”;

First, the electronic device may obtain the probability of the generated candidate sentence appearing at the beginning of the paragraph, assuming that the candidate sentence having the highest probability of appearing at the beginning of the paragraph is “Feb. 23, 2017, Beijing time,” the electronic device may use the sentence as the paragraph-initial sentence. Therefore, the electronic device selects sentences relating to the information point of “time,” all the candidate sentences containing the information point of “time” may be excluded according to the preset exclusion rule:

Excluded: {Year: 2017}, {Month: 2}, {Day: 23}==>“Feb. 23, 2017, Beijing time”;

Excluded: {Month: 2}, {Day: 23}, {Rockets: 110}, {Grizzlies: 108}, {Victory: Rockets}==>“On February 23, the Rockets beats the Grizzlies at 110: 108”;

{Rockets: 110}, {Grizzlier: 108}==>“The Rockets VS the Grizzlies”;

{Rockets: 110}, {Grizzlies: 108}, {Victory: Rockets}==>“The Rockets beats the Grizzlies by 110: 108”;

{Rockets: 110}, {Grizzlies: 108}, {Victory: Rockets}==>“The Grizzlies loses to the Rockets at 108: 110”;

{Rockets: 110}, {Grizzlies: 108}, {Victory: Rockets}==>“The Rockets edges out the Grizzlies by 2 points”;

Next, the electronic device may select the next sentence according to the connection probability between the candidate sentences corresponding to the other information points and the “Feb. 23, 2017, Beijing time,” assuming that the highest connection probability is between the “The Rockets edges out the Grizzlies by 2 points” and the “Feb. 23, 2017, Beijing time,” the electronic device may select the sentence and splice it after the “Feb. 23, 2017, Beijing time” to forma chapter. The selected sentence involves the information points “Rockets,” “Grizzlies,” “Victory,” and the electronic device may further exclude the candidate sentences relating to the information points “Rockets,” “Grizzlies” and “Victory.”

Excluded: {Year: 2017}, {Month: 2}, {Day: 23}==>“Feb. 23, 2017, Beijing time”;

Excluded: {Month: 2}, {Day: 23}, {Rockets: 110}, {Grizzlies: 108}, {Victory: Rockets}==>“On February 23, the Rockets beats the Grizzlies at 110: 108”;

Excluded: {Rockets: 110}, {Grizzlier: 108}==>“The Rockets VS the Grizzlies”;

Excluded: {Rockets: 110}, {Grizzlies: 108}, {Victory: Rockets}==>“The Rockets beats the Grizzlies by 110: 108”;

Excluded: {Rockets: 110}, {Grizzlies: 108}, {Victory: Rockets}==>“The Grizzlies loses to the Rockets at 108: 110”;

Excluded: {Rockets: 110}, {Grizzlies: 108}, {Victory: Rockets}==>“The Rockets edges out the Grizzlies by 2 points”;

In some alternative implementations of the present embodiment, the preset exclusion rule may further be other rules. For example, for each information point, a repeat occurrence weight is set, the higher the repeat occurrence weight of the information point is, the smaller the probability of excluding sentences relating to the information point, after the electronic device have selected the sentences relating to the information point. Here, the repeat occurrence weight may be acquired by counting a large number of sentence samples or by machine learning, and details description thereof is omitted.

In some alternative implementations of the present embodiment, the electronic device may further select, for each preset information point, a sentence having the highest sentence generation probability as a to-be-used sentence corresponding to the preset information point; and determine an arrangement order of the to-be-used sentence having a highest arrangement probability based on a preset chapter combination model, to form a chapter by splicing. Here, the chapter combination model may be used to calculate the sentence arrangement probability, which may acquire the connection probability between the sentences using the machine learning after segmenting the sentences of a certain number of article samples. In some implementations, the sentence arrangement probability may be calculated by the product of the connection probabilities between sentences.

Step 204, generating an article based on the chapter formed by splicing, in response to no candidate sentence being available.

In the present embodiment, the electronic device (e.g., the server 105 as shown in FIG. 1) on which the artificial intelligence based method for generating an article runs may further detect whether there is an available candidate sentence, after each time a sentence is selected and the candidate sentences relating to the selected candidate sentence are excluded, and generate an article based on the chapter formed by splicing, in response to no candidate sentence being available.

Taking the example in step 203 as an example, as the electronic device detects that no candidate sentence is available, the chapter text generation is completed. At this point, the electronic device may determine the chapter “Feb. 23, 2017, Beijing time, the Rockets edges out the Grizzlies by 2 points” formed by splicing the selected sentences as the generated article.

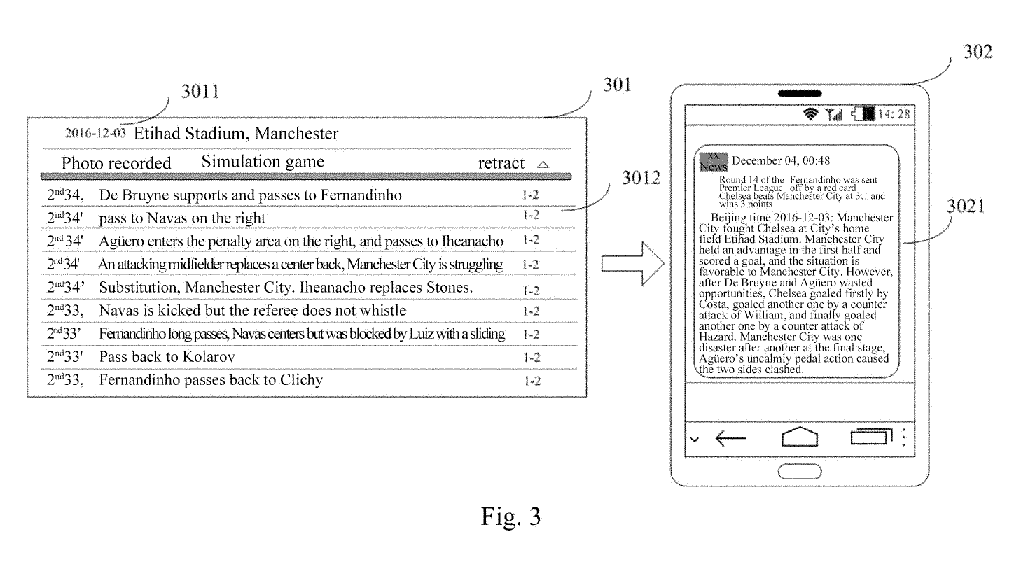

As an application scenario, the artificial intelligence based method for generating an article provided by the present disclosure may be applied to a backend server that provides support for news pushing applications. As shown in FIG. 3, when the backend server is to generate an article about a game between Manchester City and Chelsea. The backend server may first acquire non-predetermined structure data 3011 and predetermined structure data 3012 from a server that provides support for a website 301. Next, the backend server may convert the non-predetermined structure data 3011 into predetermined structure data according to the predetermined structure data 3012. Then, the backend server may generate candidate sentences from the predetermined structure data using a sentence generation model, and select candidate sentences, according to the probability for a sentence containing a preset information point (such as time, Manchester City, Chelsea, De Bruyne, Agüero) appearing, and splice the sentences to form a chapter, wherein each time a candidate sentence is selected, candidate sentences relating to the selected candidate sentence are excluded according to a preset exclusion rule. After that, the backend server may determine the article formed by splicing as the generated article 3021, in response to no candidate sentence being available. As shown in FIG. 3, the generated article 3021 may be pushed by the backend server to the terminal device 302 to be displayed.

Therefore, for the artificial intelligence based method for generating an article of the present embodiment, since the sentences may be selected by the preset information points, relevant sentences are excluded each time a sentence is selected, and until there are no available sentences the article generation is completed, thus the effectiveness of generating an article is improved.

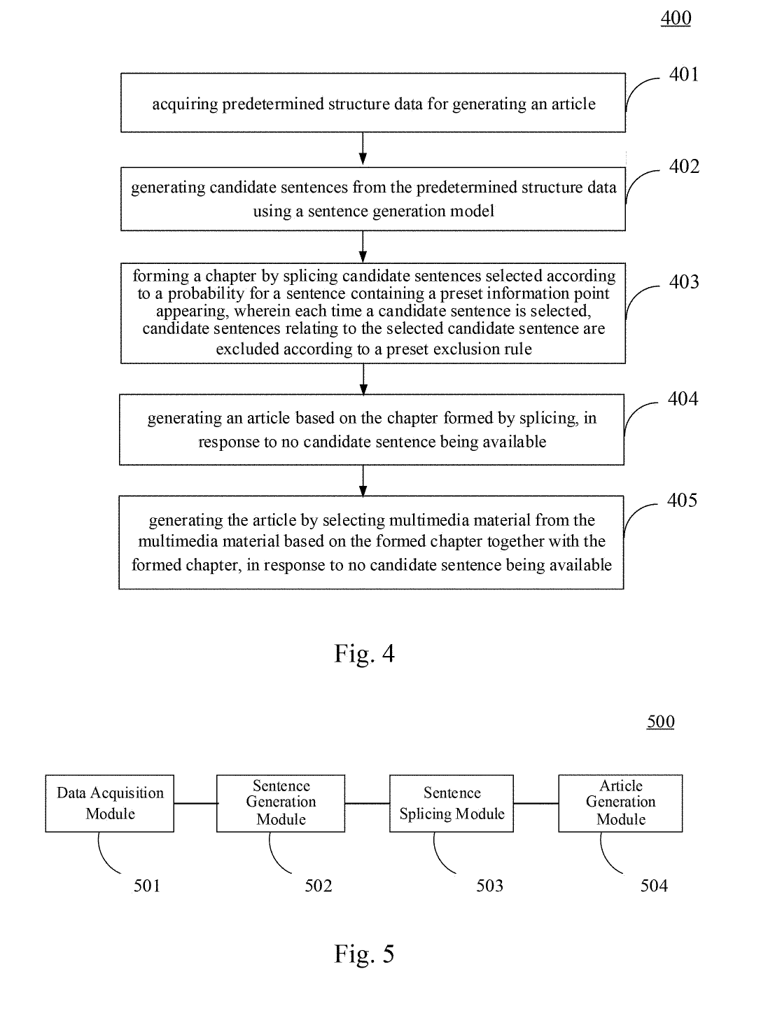

With further reference to FIG. 4, a flow 400 of another embodiment of the artificial intelligence based method for generating an article according to the present disclosure is illustrated. The artificial intelligence based method for generating an article includes the following steps:

Step 401, acquiring predetermined structure data for generating an article.

In the present embodiment, the electronic device (e.g., the server 105 as shown in FIG. 1) on which the artificial intelligence based method for generating an article runs may first acquire predetermined structure data for generating an article locally or remotely. Here, the predetermined structure data may be data having a predetermined storage structure, for example, data stored through a table, data stored through a database (such as a structured query language (SQL) database). When the data acquired by the electronic device includes non-predetermined structure data, if the acquired data further includes predetermined structure data, the electronic device may generate predetermined structure data by extracting a keyword from the non-predetermined structure data according to the acquired predetermined structure data; if the acquired data does not include predetermined structure data, the electronic device may generate predetermined structure data by extracting a keyword from the non-predetermined structure data according to a set predetermined structure data.

Step 402, generating candidate sentences from the predetermined structure data using a sentence generation model.

In the present embodiment, the electronic device (e.g., the server 105 as shown in FIG. 1) on which the artificial intelligence based method for generating an article runs may then generate candidate sentences from the predetermined structure data using a preset sentence generation model. The electronic device may generate candidate sentences by a method of filling the predetermined structure data or the information point into a preset template, may also generate candidate sentences through a machine learning model such as a multilayer Recurrent Neural Network (RNN).

Step 403, forming a chapter by splicing candidate sentences selected according to a probability for a sentence containing a preset information point appearing, wherein each time a candidate sentence is selected, candidate sentences relating to the selected candidate sentence are excluded according to a preset exclusion rule.

In the present embodiment, the electronic device (e.g., the server 105 as shown in FIG. 1) on which the artificial intelligence method for generating an article runs may preset information points required for generating an article, the electronic device may further select candidate sentences and splice the candidate sentences to form a chapter, based on the preset information points, according to the probability for the sentence containing the preset information point appearing. Here, the electronic device may further store a preset exclusion rule for excluding unusable sentences. Specifically, each time a candidate sentence is selected, the electronic device may exclude candidate sentences related to the selected candidate sentence according to the preset exclusion rule. Here, the information point is used to indicate a key point to be reflected in the article to be generated, such as time and the result of the game. The information point may be preset, or may be obtained by calculation based on the predetermined structure data.

Step 404, acquiring multimedia material associated with a theme of a to-be-generated article.

In the present embodiment, the electronic device (e.g., the server 105 as shown in FIG. 1) on which the artificial intelligence based method for generating an article runs may acquire multimedia material associated with the theme of a to-be-generated article locally or remotely. Here, the multimedia material is a combination of a variety of medias, generally includes various media forms such as text, sound and image. The multimedia material for example, may include but is not limited to, at least one of the following: a picture, an animation, an audio, and a video.

These multimedia materials may be pre-stored on the electronic device, or may be searched and acquired from other websites by the electronic device, or may be acquired by the electronic device from other electronic devices or servers, which is not limited by the present disclosure.

Step 405, generating the article by selecting multimedia material from the multimedia material based on the formed chapter together with the formed chapter, in response to no candidate sentence being available.

In the present embodiment, the electronic device (e.g., the server 105 as shown in FIG. 1) on which the artificial intelligence based method for generating an article runs may further detect whether there is an available candidate sentence, after each time a sentence is selected and candidate sentences relating to the selected candidate sentence are excluded, and may match the chapter formed by the splicing with the multimedia material acquired in step 404, and select the matched multimedia material and the formed chapter to generate an article together, in response to no candidate sentence being available.

It may be understood that when the multimedia material has a description text, the electronic device may match the description text of the multimedia material with the formed chapter. When the multimedia material does not have a description text, the electronic device may first identify the multimedia material, generate a keyword or a description text of the multimedia material, and match the generated keyword or text with the formed chapter. Upon matching, the electronic device may respectively extract keywords of the multimedia material and the formed chapter, and calculate the similarity between the keywords of the multimedia material and the formed chapter through a well-known text similarity calculation method such as a cosine similarity algorithm and a Jaccard coefficient. Taking the Jaccard coefficient method as an example, the similarity between the keywords of the multimedia material and the formed chapter is equal to the number of common words between the keywords of the multimedia material and the formed chapter divided by the total number of words included by the keywords of the multimedia material or the formed chapter. The electronic device may select the multimedia material having the obtained highest similarity to generate an article together with the formed chapter. In some implementations, the electronic device may also respectively extract semantic vectors of the multimedia material and the formed chapter, and calculate the match between the multimedia material and the formed chapter based on the semantic vectors. Here, the semantic vector may include a numerical value for denoting the vocabulary in the text. For example, the semantic vector may consist of the TF-IDF (term frequency-inverse document frequency) of each word. The match may be the inner product of the semantic vectors of the multimedia material and the formed chapter.

In some alternative implementations of the present embodiment, the electronic device may also preset a match condition of the multimedia material, for example, a keyword “Agüero,” the electronic device may select multimedia material matching the match condition from the acquired multimedia material, and generate an article together with the formed chapter.

As can be seen from FIG. 4, compared with the corresponding embodiment in FIG. 2, the flow 400 of the artificial intelligence based method for generating an article in the present embodiment highlights the step of generating an article by combining the multimedia material together with the formed chapter. Therefore, the solution described by the present embodiment may generate an article in combination with the multimedia material and may enrich the article content generated based on artificial intelligence.

With further reference to FIG. 5, as an implementation to the artificial intelligence based method for generating an article, the present disclosure provides an embodiment of an artificial intelligence based apparatus for generating an article. The apparatus embodiment corresponds to the method embodiment shown in FIG. 2.

As shown in FIG. 5, the artificial intelligence based apparatus 500 for generating an article of the present embodiment includes: a data acquisition module 501, a sentence generation module 502, a sentence splicing module 503 and an article generation module 504. Here, the data acquisition module 501 may be configured for acquiring predetermined structure data for generating an article. The sentence generation module 502 may be configured for generating candidate sentences from the predetermined structure data using a sentence generation model. The sentence splicing module 503 may be configured for forming a chapter by splicing candidate sentences selected according to a probability for a sentence containing a preset information point appearing, wherein each time a candidate sentence is selected, candidate sentences relating to the selected candidate sentence are excluded according to a preset exclusion rule. The article generation module 504 may be configured for generating an article based on the chapter formed by splicing, in response to no candidate sentence being available.

In some alternative implementations of the present embodiment, the data acquisition module 501 may be further configured for: capturing data by subject from a predetermined website, wherein the captured data includes predetermined structure data and non-predetermined structure data; and structuralizing the non-predetermined structure data according to a data structure of the predetermined structure data, into predetermined structure data.

In some alternative implementations of the present embodiments, the sentence splicing module 503 may be further configured for: selecting the candidate sentence as a paragraph-initiating sentence according to a probability for a sentence appearing at a beginning of the paragraph; selecting successively the candidate sentence according to a probability for a sentence connecting a preceding sentence and splicing the sentence to form a chapter; or selecting the candidate sentence as a paragraph-ending sentence according to a probability for a sentence appearing at an end of the paragraph; and selecting successively the candidate sentences according to a probability for a sentence connecting a rearing sentence and arranging the sentence forward to form a chapter.

In some alternative implementations of the present embodiment, the sentence splicing module 503 may be further configured for: selecting, for each preset information point, a sentence having a highest sentence generation probability as a to-be-used sentence corresponding to the preset information point; and determining an arrangement order of the to-be-used sentence having a highest arrangement probability based on a preset chapter combination model, to forma chapter by splicing.

In some alternative implementations of the present embodiment, the article generation module 504 may includes: a multimedia material acquisition unit, configured for acquiring multimedia material associated with a theme of a to-be-generated article, wherein the multimedia material includes at least one of: a picture, an animation, an audio, and a video; and an article generation unit, configured for generating the article by selecting multimedia material from the multimedia material based on the formed chapter together with the formed chapter, in response to no candidate sentence being available.

It should be noted that the modules recorded in the artificial intelligence based apparatus 500 for generating an article correspond to the steps in the method described with reference to FIG. 2. Therefore, the operations and features described above with respect to the method are also applicable to the apparatus 500 and the modules or units included therein, and detailed description thereof will be omitted.

It may be understood by those skilled in the art that the artificial intelligence based apparatus 500 for generating an article further includes some other well-known structures such as a processor, a memory. In order not to unnecessarily obscure the embodiments of the present disclosure, these well-known structures are not shown in FIG. 5.

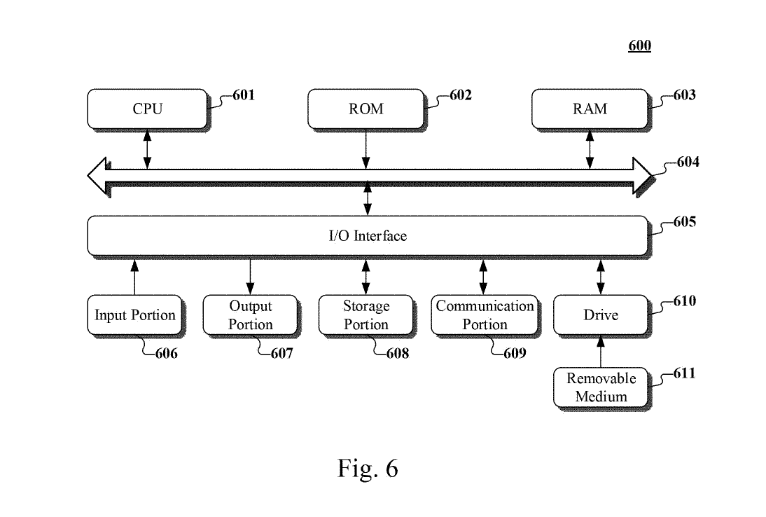

With reference to FIG. 6, a schematic structural diagram of a computer system 600 adapted to implement a terminal device/server of the embodiments of the present disclosure is illustrated. The terminal device/server shown in FIG. 6 is merely an example and should not impose any restriction on the functions and the scope of use of the embodiments of the present disclosure.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse etc.; an output portion 607 comprising a cathode ray tube (CRT), a liquid crystal display device (LCD), a speaker etc.; a storage portion 608 including a hard disk and the like; and a communication portion 609 comprising a network interface card, such as a LAN card and a modem. The communication portion 609 performs communication processes via a network, such as the Internet. A drive 610 is also connected to the I/O interface 605 as required. A removable medium 611, such as a magnetic disk, an optical disk, a magneto-optical disk, and a semiconductor memory, may be installed on the drive 610, to facilitate the retrieval of a computer program from the removable medium 611, and the installation thereof on the storage portion 608 as needed.

In particular, according to embodiments of the present disclosure, the process described above with reference to the flow chart may be implemented in a computer software program. For example, an embodiment of the present disclosure includes a computer program product, which comprises a computer program that is tangibly embedded in a machine-readable medium. The computer program comprises program codes for executing the method as illustrated in the flow chart. In such an embodiment, the computer program may be downloaded and installed from a network via the communication portion 609, and/or may be installed from the removable media 611. The computer program, when executed by the central processing unit (CPU) 601, implements the above mentioned functionalities as defined by the methods of the present disclosure. It should be noted that the computer readable medium in the present disclosure may be computer readable storage medium. An example of the computer readable storage medium may include, but not limited to: semiconductor systems, apparatus, elements, or a combination any of the above. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or any suitable combination of the above. In the present disclosure, the computer readable storage medium may be any physical medium containing or storing programs which can be used by a command execution system, apparatus or element or incorporated thereto. The computer readable medium may be any computer readable medium except for the computer readable storage medium. The computer readable medium is capable of transmitting, propagating or transferring programs for use by, or used in combination with, a command execution system, apparatus or element. The program codes contained on the computer readable medium may be transmitted with any suitable medium including but not limited to: wireless, wired, optical cable, RF medium etc., or any suitable combination of the above.

The flow charts and block diagrams in the accompanying drawings illustrate architectures, functions and operations that may be implemented according to the systems, methods and computer program products of the various embodiments of the present disclosure. In this regard, each of the blocks in the flow charts or block diagrams may represent a module, a program segment, or a code portion, said module, program segment, or code portion comprising one or more executable instructions for implementing specified logic functions. It should also be noted that, in some alternative implementations, the functions denoted by the blocks may occur in a sequence different from the sequences shown in the figures. For example, any two blocks presented in succession may be executed, substantially in parallel, or they may sometimes be in a reverse sequence, depending on the function involved. It should also be noted that each block in the block diagrams and/or flow charts as well as a combination of blocks may be implemented using a dedicated hardware-based system executing specified functions or operations, or by a combination of a dedicated hardware and computer instructions.

The units or modules involved in the embodiments of the present application may be implemented by means of software or hardware. The described units or modules may also be provided in a processor, for example, described as: a processor, comprising a data acquisition module, a sentence generation module, a sentence splicing module and an article generation module, where the names of these units or modules do not in some cases constitute a limitation to such units or modules themselves. For example, the data acquisition module may also be described as “a module configured for acquiring predetermined structure data for generating an article.”

In another aspect, the present application further provides a non-volatile computer-readable storage medium. The non-volatile computer-readable storage medium may be the non-volatile computer-readable storage medium included in the apparatus in the above described embodiments, or a stand-alone non-volatile computer-readable storage medium not assembled into the apparatus. The non-volatile computer-readable storage medium stores one or more programs. The one or more programs, when executed by a device, cause the device to: acquire predetermined structure data for generating an article; generate candidate sentences from the predetermined structure data using a sentence generation model; form a chapter by splicing candidate sentences selected according to a probability for a sentence containing a preset information point appearing, wherein each time a candidate sentence is selected, candidate sentences relating to the selected candidate sentence are excluded according to a preset exclusion rule; and generate an article based on the chapter formed by splicing, in response to no candidate sentence being available.

The above description only provides an explanation of the preferred embodiments of the present application and the technical principles used. It should be appreciated by those skilled in the art that the inventive scope of the present application is not limited to the technical solutions formed by the particular combinations of the above-described technical features. The inventive scope should also cover other technical solutions formed by any combinations of the above-described technical features or equivalent features thereof without departing from the concept of the disclosure. Technical schemes formed by the above-described features being interchanged with, but not limited to, technical features with similar functions disclosed in the present application are examples.

What is claimed is:

1. An artificial intelligence based method for generating an article, the method comprising:
acquiring predetermined structure data for generating an article;
generating candidate sentences from the predetermined structure data using a sentence generation model;
forming a chapter by splicing candidate sentences selected according to a probability for a sentence containing a preset information point appearing, wherein each time a candidate sentence is selected, candidate sentences relating to the selected candidate sentence are excluded according to a preset exclusion rule; and
generating an article based on the chapter formed by splicing, in response to no candidate sentence being available.

2. The method according to claim 1, wherein the acquiring predetermined structure data for generating an article comprises:
capturing data by subject from a predetermined website, wherein the captured data includes predetermined structure data and non-predetermined structure data; and
structuralizing the non-predetermined structure data according to a data structure of the predetermined structure data, into predetermined structure data.

3. The method according to claim 1, wherein the forming a chapter by splicing candidate sentences selected according to a probability for a sentence containing a preset information point appearing comprises:
selecting the candidate sentence as a paragraph-initiating sentence according to a probability for a sentence appearing at a beginning of the paragraph;
selecting successively the candidate sentence according to a probability for a sentence connecting a preceding sentence and splicing the sentence to form a chapter; or
selecting the candidate sentence as a paragraph-ending sentence according to a probability for a sentence appearing at an end of the paragraph; and
selecting successively the candidate sentences according to a probability for a sentence connecting a rearing sentence and arranging the sentence forward to form a chapter.

4. The method according to claim 1, wherein the forming a chapter by splicing candidate sentences selected according to a probability for a sentence containing a preset information point appearing comprises:
selecting, for each preset information point, a sentence having a highest sentence generation probability as a to-be-used sentence corresponding to the preset information point; and
determining an arrangement order of the to-be-used sentence having a highest arrangement probability based on a preset chapter combination model, to form a chapter by splicing.

5. The method according to claim 1, wherein the generating an article based on the chapter formed by splicing, in response to no candidate sentence being available comprises:
acquiring multimedia material associated with a theme of a to-be-generated article, wherein the multimedia material includes at least one of: a picture, an animation, an audio, and a video; and
generating the article by selecting multimedia material from the multimedia material based on the formed chapter together with the formed chapter, in response to no candidate sentence being available.

6. An artificial intelligence based apparatus for generating an article, the apparatus comprising:
at least one processor; and
a memory storing instructions, the instructions when executed by the at least one processor, cause the at least one processor to perform operations, the operations comprising:
acquiring predetermined structure data for generating an article;
generating candidate sentences from the predetermined structure data using a sentence generation model;
forming a chapter by splicing candidate sentences selected according to a probability for a sentence containing a preset information point appearing, wherein each time a candidate sentence is selected, candidate sentences relating to the selected candidate sentence are excluded according to a preset exclusion rule; and
generating an article based on the chapter formed by splicing, in response to no candidate sentence being available.

7. The apparatus according to claim 6, wherein the acquiring predetermined structure data for generating an article comprises:
capturing data by subject from a predetermined website, wherein the captured data includes predetermined structure data and non-predetermined structure data; and
structuralizing the non-predetermined structure data according to a data structure of the predetermined structure data, into predetermined structure data.

8. The apparatus according to claim 6, wherein forming a chapter by splicing candidate sentences selected according to a probability for a sentence containing a preset information point appearing comprises:
selecting the candidate sentence as a paragraph-initiating sentence according to a probability for a sentence appearing at a beginning of the paragraph;
selecting successively the candidate sentence according to a probability for a sentence connecting a preceding sentence and splicing the sentence to form a chapter; or
selecting the candidate sentence as a paragraph-ending sentence according to a probability for a sentence appearing at an end of the paragraph; and
selecting successively the candidate sentences according to a probability for a sentence connecting a rearing sentence and arranging the sentence forward to form a chapter.

9. The apparatus according to claim 6, wherein forming a chapter by splicing candidate sentences selected according to a probability for a sentence containing a preset information point appearing comprises:
selecting, for each preset information point, a sentence having a highest sentence generation probability as a to-be-used sentence corresponding to the preset information point; and
determining an arrangement order of the to-be-used sentence having a highest arrangement probability based on a preset chapter combination model, to form a chapter by splicing.

10. The apparatus according to claim 6, wherein the generating an article based on the chapter formed by splicing, in response to no candidate sentence being available comprises:
acquiring multimedia material associated with a theme of a to-be-generated article, wherein the multimedia material includes at least one of: a picture, an animation, an audio, and a video; and
generating the article by selecting multimedia material from the multimedia material based on the formed chapter together with the formed chapter, in response to no candidate sentence being available.

11. A non-transitory computer storage medium storing a computer program, the computer program when executed by one or more processors, causes the one or more processors to perform operations, the operations comprising:
acquiring predetermined structure data for generating an article;
generating candidate sentences from the predetermined structure data using a sentence generation model;
forming a chapter by splicing candidate sentences selected according to a probability for a sentence containing a preset information point appearing, wherein each time a candidate sentence is selected, candidate sentences relating to the selected candidate sentence are excluded according to a preset exclusion rule; and
generating an article based on the chapter formed by splicing, in response to no candidate sentence being available.
